(19) United States
(12) Patent Application Publication
(10) Pub. No.: US 2026/0202126 A1
(43) Pub. Date: Jul. 16, 2026

(54) LASER DRYING DEVICE

(71) Applicant: TOYOTA JIDOSHA KABUSHIKI KAISHA, Aichi-ken (JP)

(72) Inventors: Masato ONO, Nagoya-shi (JP); Tadashi TERANISHI, Toyota-shi (JP); Yusuke OISHI, Toyota-shi (JP); Tomofumi HIRUKAWA, Miyoshi-shi (JP); Yosuke SHIMURA, Nagakute-shi (JP); Hiroshi KAWASAKI, Toyota-shi (JP); Katsuhisa TSUZUKI, Toyota-shi (JP); Takashi IZU, Kashiba-shi (JP)

(21) Appl. No.: 19/443,018

(22) Filed: Jan. 8, 2026

(30) Foreign Application Priority Data
Jan. 14, 2025 (JP) 2025-004985

(51) Int. Cl. F26B 3/28; H01M 4/04

(52) U.S. Cl. CPC F26B 3/28; H01M 4/04

(57) ABSTRACT

A laser drying device for drying an electrode mixture layer, wherein the laser drying device includes a laser light source and a furnace body, a laser-transmitting protective plate laminate of the furnace body has a multilayer structure in which a protective plate (upper layer) and a protective plate (lower layer) are stacked, the protective plate (upper layer) and the protective plate (lower layer) are formed by arranging respective protective plate pieces (upper layer) and protective plate pieces (lower layer) in a plane direction, and when the laser-transmitting protective plate laminate is viewed in a stacking direction, boundaries between the plurality of protective plate pieces (upper layer) do not coincide with boundaries between the plurality of protective plate pieces (lower layer).

### FIELD

The present disclosure relates to a laser drying device.

### BACKGROUND

As a method for drying an electrode mixture layer applied upon a current collector layer, laser drying is known. Laser drying consumes less energy than hot air drying and has a lower environmental impact. Various proposals for improving the drying efficiency and quality of laser drying have been made.

Patent Literature 1 discloses a method for the production of an electrode assembly, comprising a conveying step of conveying an electrode assembly to which at least one electrode material has been applied by means of a conveyor, and a drying step of drying the electrode material while conveying the electrode assembly by means of the conveyor, wherein the drying step includes an irradiation step of irradiating the electrode material with a laser while the electrode assembly is conveyed to at least one first position in the conveyance direction of the conveyor to dry the electrode material, and a recovery step of recovering vapor generated by the laser irradiation of the electrode material by a vapor recovery unit provided in at least one second position adjacent to the first position in the conveyance direction. Patent Literature 1 describes that, according to the disclosure of Patent Literature 1, a reduction in drying efficiency when the electrode material is dried by means of a laser can be suppressed.

Patent Literature 2 discloses a method for the production of a battery electrode in which an active material is affixed to a current collecting substrate, the method comprising a first step of providing a powder active material at a predetermined thickness, and a second step of scanning the powder active material with a laser to bond the powder active material and affix the active material to the current collecting substrate by irradiating the active material with heat from the laser light, wherein the first and second steps are repeated until the active material reaches a predetermined thickness on the current collecting substrate. Patent Literature 2 describes that, according to the disclosure of Patent Literature 2, filling of the active material and electrical resistance can be improved while ensuring production efficiency, and the porosity of the active material can be adjusted in accordance with the particle size of the powder and heating conditions, thereby improving lithium ion permeability.

Patent Literature 3 discloses a method for the production of an electrode sheet, comprising a preparation step of preparing a coated sheet having a coated portion to which an electrode material has been applied on a first surface of a current collecting sheet having a longitudinal direction in a first direction, and a drying step of conveying the coated sheet in the first direction while irradiating the coated portion with laser light from a plurality of laser heads arranged in the first direction to dry the coated portion, whereby an electrode sheet is obtained, wherein the drying step comprises supplying hot air at a temperature of 50° C. or higher and 140° C. or lower and at an air speed of 5 m/s or higher to the laser-irradiated portions of the conveyed coated sheet which have been irradiated with laser light from each laser head until a subsequent laser irradiation. Patent Literature 3 describes that, according to the disclosure of Patent Literature 3, an electrode sheet in which an increase in drying time is suppressed while a decrease in peel strength between the electrode layer and the current collecting sheet is suppressed can be produced.

### CITATION LIST

### Patent Literature

[PTL 1] Japanese Unexamined Patent Publication (Kokai) No. 2023-169591
[PTL 2] Japanese Unexamined Patent Publication (Kokai) No. 2007-52934
[PTL 3] Japanese Unexamined Patent Publication (Kokai) No. 2024-20819

### SUMMARY

### Technical Problem

By providing a furnace body with a laser-transparent protective plate, and irradiating an electrode mixture layer inside the furnace body with laser light from a laser light source outside the furnace through the protective plate, it is not necessary to arrange the laser light source inside the high-temperature furnace body, and the laser light source and the furnace body can be thermally insulated.

In this case, by reducing the distance between the protective plate and the electrode mixture layer, the size of the furnace body can be reduced, improving drying efficiency. On the other hand, in this case, since the distance between the protective plate and the laser light source becomes greater, and the irradiated area of the laser light on the protective plate becomes larger, a large-area protective plate is necessary.

However, it is difficult to prepare a single large-area protective plate made of quartz glass, etc. One approach to this problem is to arrange a plurality of protective plate pieces side-by-side in a plane direction to construct a protective plate, but this can lead to drying unevenness in the electrode mixture layer due to differences in transmittance of the laser light between the protective plate pieces themselves and the boundaries therebetween.

Thus, an object of the present disclosure is to provide a laser drying device which can suppress drying unevenness in the electrode mixture layer, even when a plurality of protective plate pieces are arranged side-by-side in the plane direction to form a large-area protective plate.

### Solution to Problem

The present disclosure achieves the object described above by the following means.

### <Aspect 1>

A laser drying device for drying an electrode mixture layer, wherein
the laser drying device comprises a laser light source and a furnace body,
the laser light source irradiates the electrode mixture layer with laser light through a laser-transmitting protective plate laminate of the furnace body to heat and dry the electrode mixture layer,
the protective plate laminate has a multilayer structure in which a plurality of protective plates are stacked,
the protective plates are formed by juxtaposing a plurality of protective plate pieces in a plane direction, and
when the protective plate laminate is viewed in a stacking direction, boundaries between the protective plate pieces forming one protective plate do not coincide with boundaries between the protective plate pieces forming another adjacent protective plate.

### <Aspect 2>

The device according to Aspect 1, wherein two of the protective plates which are adjacent to each other are bonded to each other via a fluorine resin film.

### <Aspect 3>

The device according to Aspect 1 or 2, wherein when a distance between the laser light source and the electrode mixture layer is defined as x and a distance between the protective plate laminate and the electrode mixture layer is defined as y, the following relationship is satisfied:

$$y / x \leq 0.15 .$$

### <Aspect 4>

The device according to any one of Aspects 1 to 3, wherein the furnace body further comprises hot air supply equipment.

### <Aspect 5>

A method for the production of an electrode laminate using the device according to any one of Aspects 1 to 4, the method comprising the step of:
irradiating the electrode mixture layer applied to a current collector layer with laser light from the laser light source through the laser-transmitting protective plate laminate.

### Advantageous Effects of Invention

According to the present disclosure, there can be provided a laser drying device which can suppress drying unevenness in the electrode mixture layer, even when a plurality of protective plate pieces are arranged side-by-side in the plane direction to form a large-area protective plate.

### BRIEF DESCRIPTION OF DRAWINGS

FIG. 1 is a schematic view detailing a laser drying device of the present disclosure.

FIG. 2 is a schematic view detailing the laser drying device of the present disclosure.

FIG. 3 is a schematic view detailing the laser drying device of the present disclosure.

FIG. 4A is a schematic view detailing the laser drying device of the present disclosure.

FIG. 4B is a schematic view detailing the laser drying device of the present disclosure.

FIG. 5A is a schematic view detailing Examples of the present disclosure and a Comparative Example.

FIG. 5B is a schematic view detailing Examples of the present disclosure and a Comparative Example.

FIG. 5C is a schematic view detailing Examples of the present disclosure and a Comparative Example.

### DESCRIPTION OF EMBODIMENTS

### <<Laser Drying Device>>

A laser drying device for drying an electrode mixture layer, wherein
the laser drying device comprises a laser light source and a furnace body,
the laser light source irradiates the electrode mixture layer with laser light through a laser-transmitting protective plate laminate of the furnace body to heat and dry the electrode mixture layer,
the protective plate laminate has a multilayer structure in which a plurality of protective plates are stacked,
the protective plates are formed by juxtaposing a plurality of protective plate pieces in a plane direction, and
when the protective plate laminate is viewed in a stacking direction, boundaries between the protective plate pieces forming one protective plate do not coincide with boundaries between the protective plate pieces forming another adjacent protective plate.

According to the present disclosure, there can be provided a laser drying device which can suppress drying unevenness in the electrode mixture layer, even when a plurality of protective plate pieces are arranged side-by-side in the plane direction to form a large-area protective plate.

The present inventors have investigated, in order to thermally insulate the laser light source from the furnace body interior when laser drying the electrode mixture layer, arranging a protective plate on the furnace body so that the electrode mixture layer is irradiated with laser light from the laser light source through the protective plate, and reducing the distance between the protective plate and the electrode mixture layer to improve drying efficiency. It was discovered that when a large-area protective plate in which a plurality of protective plate pieces are arranged side-by-side is used to reduce the distance between the protective plate and the electrode mixture layer, the laser light transmittance differed between the protective plate pieces themselves and the boundaries between the plurality of protective plate pieces, resulting in variations in the intensity of the laser light with which the electrode mixture layer is irradiated, resulting in uneven drying of the electrode mixture layer.

In response to this, the present inventors have discovered that drying unevenness in the electrode mixture layer can be suppressed by using a laser-transmitting protective plate laminate having a multilayer structure in which a plurality of protective plates are stacked. Specifically, according to the laser drying device of the present disclosure, since the boundaries between the plurality of protective plate pieces forming one protective plate do not coincide with the boundaries between the plurality of protective plate pieces forming the adjacent other protective plate when the protective plate laminate is viewed in the stacking direction, variation in the intensity of the laser light with which the electrode mixture layer is irradiated can be reduced, suppressing drying unevenness. Furthermore, according to the laser drying device of the present disclosure, since the distance between the laser-transmitting protective plate laminate and the electrode mixture layer in the furnace body can be reduced, drying efficiency can be improved.

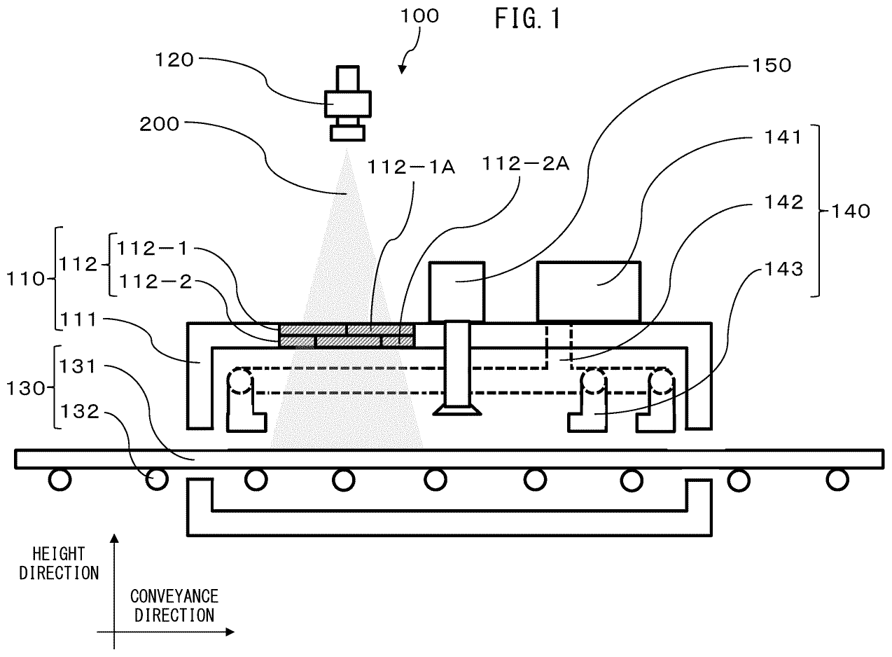

Specifically, as shown in, for example, FIG. 1, the laser drying device 100 comprises a furnace body 110 and a laser light source 120. The laser drying device 100 further comprises conveying equipment 130, and by rotating conveyor rollers 132, the electrode mixture layer arranged on a conveyor belt 131 is moved at a constant speed in the conveyance direction. Thus, the electrode mixture layer can be introduced from outside of the furnace body 110 to the interior of the furnace body 110, and the electrode mixture layer can be conveyed from the interior of the furnace body 110 to the outside of the furnace body 110.

The furnace body 110 is constituted by an exterior base material 111 and a laser-transmitting protective plate laminate 112. The electrode mixture layer introduced into the interior of the furnace body 110 by the conveying equipment 130 is irradiated with laser light 200 from the laser light source 120 arranged outside the furnace body 110 via the laser-transmitting protective plate laminate 112.

The laser-transmitting protective plate laminate 112 has a multilayer structure in which a protective plate (upper layer) 112-1 and a protective plate (lower layer) 112-2 are stacked in the stacking direction. The protective plate (upper layer) 112-1 is formed by arranging a plurality of protective plate pieces (upper layer) 112-1A side-by-side in the plane direction, and the protective plate (lower layer) 112-2 is formed by arranging a plurality of protective plate pieces (lower layer) 112-2A side-by-side in the plane direction. When the laser-transmitting protective plate laminate 112 is viewed from the stacking direction (height direction), since the boundaries of the protective plate pieces (upper layer) 112-1A constituting the protective plate (upper layer) 112-1 and the boundaries of the protective plate pieces (lower layer) 112-2A constituting the protective plate (lower layer) 112-2 do not coincide with each other, variations in the intensity of the laser light with which the electrode mixture layer is irradiated can be reduced, whereby the electrode mixture layer can be uniformly dried.

Furthermore, the laser drying device 100 comprises hot air supply equipment 140, and the hot air supply equipment 140 is constituted by a hot air generator 141, an air supply duct 142, and an air supply nozzle 143. The hot air supply equipment 140 supplies hot air generated by the hot air generator 141 to the interior of the furnace body 110 via the air supply duct 142 and the air supply nozzle 143. The hot air is supplied in the conveyance direction and in the direction opposite the conveyance direction. Steam generated near the surface of the electrode mixture layer due to the laser irradiation is removed by the hot air and is then exhausted outside the furnace body 110 by exhaust equipment 150. As a result, drying efficiency of the electrode mixture layer can be increased.

Note that though the interior of the furnace body 110 is heated to a high temperature by the hot air, since the laser-transmitting protective plate laminate 112 is present between the laser light source 120 and the interior of the furnace body 110, the laser light source 120 is protected from the heat in the interior of the furnace body 110, which is not transferred thereto.

The embodiments of the present disclosure will be described in detail below. Note that the present disclosure is not limited to the following embodiments, and various modifications can be made within the scope of the spirit of the present disclosure.

The laser drying device of the present disclosure is a laser drying device for drying an electrode mixture layer.

The phrase “electrode mixture” as used herein refers to a composition that can constitute an electrode active material layer either as-is or by further containing other components. Further, the phrase “electrode mixture layer” refers to a layer which contains a dispersion medium in addition to the “electrode mixture” and which can be applied and dried to form an electrode active material layer.

The laser drying device of the present disclosure comprises a furnace body and a laser light source. The laser drying device may further comprise hot air supply equipment, conveying equipment, and exhaust equipment.

When the distance between the laser light source and the electrode mixture layer is defined as x, and the distance between the laser-transmitting protective plate and the electrode mixture layer is defined as y, y/x≤0.15, 0.14, 0.13, 0.12, 0.10, 0.08, or 0.05 may be satisfied. By satisfying the above relationship, drying efficiency of the electrode mixture layer is increased. Furthermore, y/x≥0.01, 0.02, 0.03, or 0.04 may be satisfied.

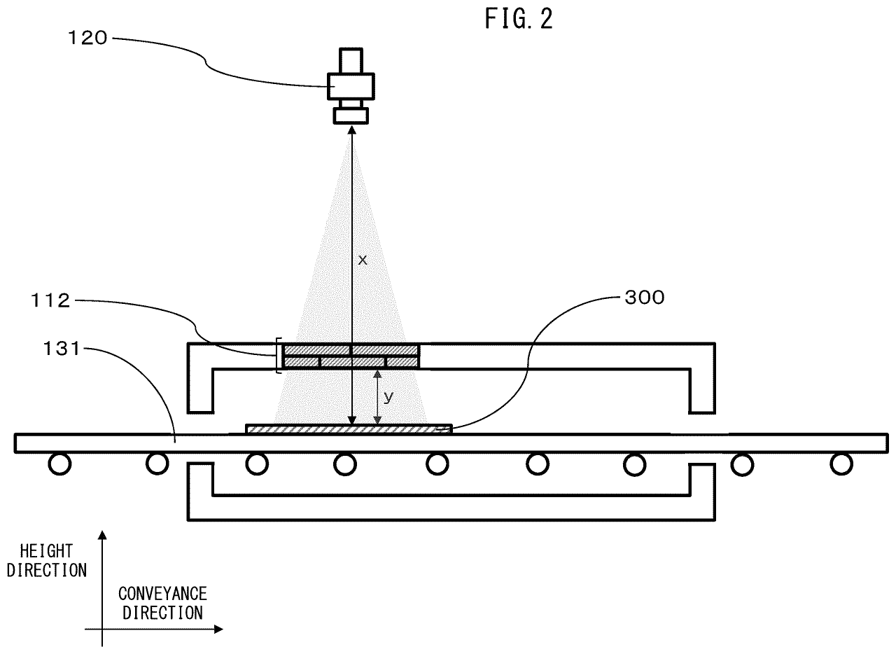

Specifically, as shown in, for example, FIG. 2, an electrode mixture layer 300 is arranged on the conveyor belt 131 and is irradiated with laser light. The distance x described above is the shortest distance from the laser light irradiation portion of the laser light source 120 to the electrode mixture layer 300 in the height direction. Furthermore, the distance y described above is the shortest distance from the laser-transmitting protective plate laminate 112 to the electrode mixture layer 300 in the height direction.

The distance x between the laser light source and the electrode mixture layer is not particularly limited, and may be appropriately determined in consideration of the irradiation area of the laser light, etc. The distance x may be, for example, 300 mm or more, 500 mm or more, 1000 mm or more, 1500 mm or more, or 2000 mm or more, and may be 5000 mm or less, 4000 mm or less, or 3000 mm or less. The laser light source may be arranged in the interior of the furnace body, or may be arranged outside the furnace body.

The distance y between the laser-transmitting protective plate laminate and the electrode mixture layer is not particularly limited, and may be appropriately determined in consideration of y/x, the thickness of the electrode mixture layer, etc. The distance y may be, for example, 5 mm or more, 10 mm or more, 30 mm or more, 50 mm or more, or 100 mm or more, and may be 750 mm or less, 500 mm or less, 400 mm or less, or 300 mm or less.

### <Furnace Body>

The furnace body comprises a laser-transmitting protective plate laminate. As shown in FIG. 1, the furnace body includes an exterior base material and a laser-transmitting protective plate laminate. At least a part of the exterior of the furnace body may be the laser-transmitting protective plate laminate. The laser-transmitting protective plate laminate may be arranged at a position where the electrode mixture layer can be thoroughly irradiated with the laser light generated from the laser light source via the laser-transmitting protective plate laminate.

The material of the exterior base material is not particularly limited, and may be, for example, steel, stainless steel, aluminum, etc. The exterior base material may be surface-treated by galvanization, powder coating, etc. The size of the furnace body is not particularly limited, and may be appropriately determined in consideration of the dimensions of the electrode mixture layer, etc.

The dimensions of the furnace body are not particularly limited and may be appropriately determined in consideration of the dimensions of the electrode mixture layer, etc. The furnace body may also have an opening for carrying in and out the electrode mixture layer using conveying equipment.

The furnace body preferably has high thermal insulation properties from the viewpoint of increasing drying efficiency of the electrode mixture layer, and may have a thermal insulation material on the outside of the exterior base material. Examples of the thermal insulation material include fire brick, ceramic fiber, and glass wool.

### (Laser-Transmitting Protective Plate Laminate)

The laser protective plate laminate has a multilayer structure in which a plurality of protective plates are stacked. The number of stacked protective plates is not particularly limited, and is preferably a number which prevents the positions of boundaries of the protective plate pieces constituting each protective plate from being displaced when the laser protective plate laminate is viewed from the stacking direction. The number of stacked protective plates may be, for example, two or more, three or more, four or more, or five or more, and may be ten or fewer, nine or fewer, eight or fewer, or seven or fewer.

Two adjacent protective plates may be bonded to each other via a fluororesin film. By interposing the fluororesin film, the thermal insulation of the laser protective plate laminate can be improved. Furthermore, since the fluororesin film has high laser transmittance, it has little impact on drying efficiency.

The fluororesin film is a thin film of a resin containing fluorine, and examples of the material include fluoroethylene propylene (FEP) and polytetrafluoroethylene (PTFE).

The thickness of the fluororesin film is not particularly limited, and may be appropriately determined in consideration of thermal insulating performance and drying efficiency of the laser protective plate laminate. The thickness may be, for example, 10 μm or more, 50 μm or more, or 100 μm or more, and may be 300 μm or less, 250 μm or less, or 200 μm or less.

Two adjacent protective plates may be bonded together with an adhesive. The adhesive is preferably an adhesive which is suitable for optical devices, has high laser light transmittance, and has high thermal resistance. The adhesive may be, for example, an ultraviolet-curing adhesive or an epoxy-based adhesive.

An air gap may be provided between two adjacent protective plates. By providing an air gap, thermal insulation of the laser protective plate laminate can be improved.

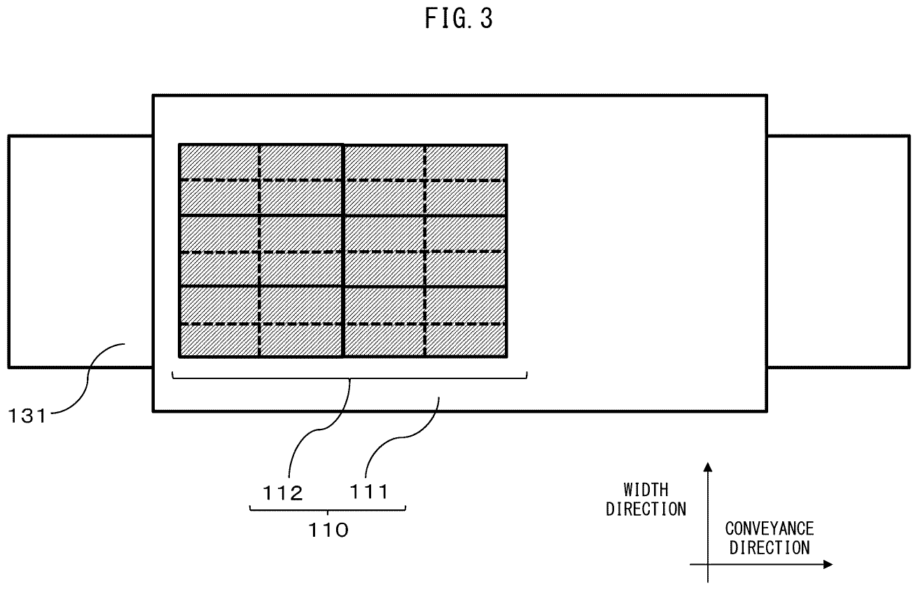

The protective plate is formed by arranging a plurality of protective plate pieces side-by-side in the plane direction. In the present disclosure, the “plane direction” of the protective plate pieces refers to the direction parallel to the primary surface (largest surface) of the protective plate pieces. Specifically, for example, this refers to any direction perpendicular to the height direction in FIG. 1. As shown in FIG. 3, the protective plate pieces may be arranged in the width direction and the conveyance direction. Note that the laser-transmitting protective plate laminate 112 of FIG. 3 is a top view of the laser-transmitting protective plate laminate 112 of FIG. 1, and is formed by stacking protective plates (upper layer) 112-1 and protective plates (lower layer) 112-2. The boundaries between the six protective plate pieces constituting the protective plate (upper layer) 112-1 are indicated by solid lines, and the boundaries between the twelve protective plate pieces constituting the protective plate (lower layer) 112-2 are indicated by dashed lines.

The number of protective plate pieces is not particularly limited, and may be appropriately determined in consideration of the positional relationship of the boundaries of the protective plates, the dimensions of the protective plate pieces, and the area of the laser-transmitting protective plate laminate irradiated with the laser light.

When the protective plate laminate is viewed in the stacking direction, the boundaries between the plurality of protective plate pieces forming one protective plate do not coincide with the boundaries between the plurality of protective plate pieces forming the adjacent protective plate. The “stacking direction” refers to the height direction in FIG. 1, and FIG. 3 is a view of the laser-transmitting protective plate laminate 112 as viewed in the stacking direction. The “boundaries between the plurality of protective plate pieces forming one protective plate do not coincide with the boundaries between the plurality of protective plate pieces forming the adjacent protective plate” means that, in FIG. 3, the boundaries of the protective plate pieces in the upper layer do not at least partially coincide with the boundaries of the protective plate pieces forming the lower layer. Specifically, this means that there are dashed lines in FIG. 3 that do not overlap with the solid lines.

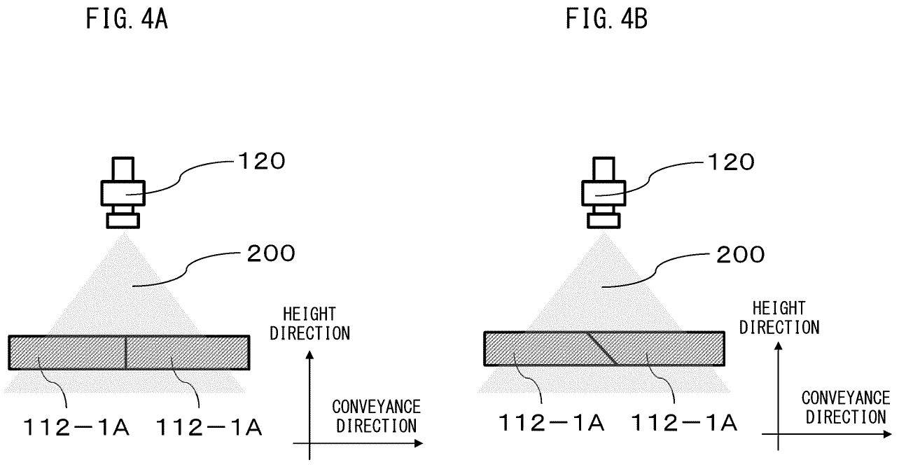

The boundary surface of two adjacent protective plate pieces in the planar direction may be parallel to the height direction as shown in FIG. 4A, or may be inclined rather than parallel to the height direction as shown in FIG. 4B. By inclining the boundary surface, the boundary surface of the two protective plate pieces can be made non-parallel to the irradiation direction of the laser light 200 even directly below the laser light source 120, which alleviates the impact of the boundary and suppresses drying unevenness.

Two protective plate pieces which are adjacent to each other in the plane direction may be bonded together with an adhesive. The adhesive is preferably an adhesive which is suitable for optical devices, has high laser light transmittance, and has high thermal resistance. The adhesive may be, for example, an ultraviolet-curing adhesive or an epoxy adhesive.

The laser light transmittance of the protective plate pieces, with respect to the laser light emitted from the laser light source, may be 95.0% or more, 96.0% or more, 97.0% or more, 98.0% or more, 99.0% or more, 99.5% or more, 99.8% or more, and may be 100.0% or less or 99.9% or less. By adopting high laser light transmittance, the light energy generated from the laser light source can efficiently be supplied to the electrode mixture layer.

The transmittance of laser light is the transmittance at a single wavelength when the laser light is of a single wavelength, and is the transmittance at the wavelength having the highest intensity when the laser light is of multiple wavelengths. The transmittance of laser light can be measured by spectrophotometry using a UV-Vis-NIR spectrophotometer (SolidSpec-3700 DUV, manufactured by Shimadzu Corporation).

The material of the protective plate pieces may be a glass. The glass may be, for example, quartz glass, soda-lime glass, lead glass, borosilicate glass, or alkali glass.

The protective plate pieces may be double-glazed glass, which improves heat insulation performance. The double-glazed glass may be formed by sealing air, argon gas, krypton gas, etc., between a plurality of panes of glass.

The thickness of the protective plate pieces is not particularly limited, and may be appropriately determined in accordance with the material of the laser-transmitting protective plate pieces, etc. The thickness of the laser-transmitting protective plate pieces may be, for example, 1 mm or more, 3 mm or more, 5 mm or more, 7 mm or more, or 10 mm or more, and may be 30 mm or less, 25 mm or less, 20 mm or less, or 15 mm or less.

The dimensions of the protective plate pieces are not particularly limited, and may be selected such that the laser light generated from the laser light source can thoroughly pass therethrough to the furnace body interior when the plurality of transmitting plate pieces are combined.

The thermal conductivity of the protective plate pieces is not particularly limited, and may be 1.50 W/(M·K) or less, 1.40 W/(M·K) or less, 1.38 W/(M·K) or less, 1.35 W/(M·K) or less, 1.30 W/(M·K) or less, 1.20 W/(M·K) or less, 1.10 W/(M·K) or less, or 1.00 W/(M·K) or less, and may be 0.10 W/(M·K) or more, 0.30 W/(M·K) or more, or 0.50 W/(M·K) or more. By adopting a low thermal conductivity, the laser light source is less likely to be impacted by the temperature of the furnace body interior.

The thermal conductivity can be measured by the heat flow meter method in accordance with ASTEM-E-1530.

### <Laser Light Source>

The laser light source irradiates the electrode mixture layer with laser light through the laser-transmitting protective plate laminate of the furnace body, heating and drying the electrode mixture layer.

The energy density of the laser light emitted from the laser light source onto the electrode mixture layer in the drying furnace is not particularly limited, and may be, for example, 0.1 W/cm² or more, 0.5 W/cm² or more, 1.0 W/cm² or more, 2.0 W/cm² or more, or 3.0 W/cm² or more, and may be 20.0 W/cm² or less, 10.0 W/cm² or less, 7.0 W/cm² or less, or 4.0 W/cm² or less.

The laser light source may be arranged outside the furnace body. By arranging the insulated laser light source outside the furnace body, the laser light source can be protected from high heat when the interior of the furnace body is at high temperature.

The type of the laser light source is not particularly limited, and may be, for example, a Yb fiber laser, a YAG laser, or a carbon dioxide laser. The wavelength of the laser light may be 0.5 μm or more, 0.6 μm or more, 0.7 μm or more, 0.8 μm or more, or 0.9 μm or more, and may be 1.5 μm or less, 1.4 μm or less, 1.3 μm or less, 1.2 μm or less, or 1.1 μm or less. The laser light may be of a single wavelength or of multiple wavelengths.

The output of the laser light source is not particularly limited, and may be appropriately determined in accordance with the irradiation area of the laser light, the possible irradiation time of the laser light, etc. The output of the laser light source may be, for example, 0.1 kW or more, 1 kW or more, 5 kW or more, 10 kW or more, 15 KW or more, 20 kW or more, or 30 kW or more, and may be 100 kW or less, 70 kW or less, or 50 kW or less.

The number of laser light sources is not particularly limited, and may be appropriately determined in accordance with the irradiation area of the laser light, the possible irradiation time of the laser light, etc. The number of laser light sources may be, for example, 1 or more, 2 or more, 3 or more, 5 or more, or 10 or more, and may be 30 or less, or 20 or less.

The shape of the area of the electrode mixture layer irradiated with the laser light may be, for example, rectangular. The size of the area of irradiation is not particularly limited, and may be appropriately determined in accordance with the dimensions of the electrode mixture layer.

### <Hot Air Supply Equipment>

The hot air supply equipment supplies hot air into the interior of the furnace body. By supplying hot air to the electrode mixture layer, steam can be removed from the surface of the electrode mixture layer, improving drying efficiency.

The temperature of the hot air supplied from the hot air supply equipment may be 50° C. or higher, 100° C. or higher, 130° C. or higher, 150° C. or higher, 160° C. or higher, 180° C. or higher, 200° C. or higher, 220° C. or higher, 240° C. or higher, 260° C. or higher, 280° C. or higher, or 300° C. or higher, and may be 500° C. or lower, 450° C. or lower, 400° C. or lower, or 350° C. or lower.

The hot air supply equipment is not particularly limited, and may be configured to supply air heated by, for example, gas combustion, oil combustion, electric heating, etc., to the electrode mixture layer by a blower fan through a blower duct and a blower nozzle. From the viewpoint of drying of the electrode mixture layer, it is preferable that the hot air have low humidity.

The supply direction of the hot air is not particularly limited, and may be the direction opposite to the conveyance direction when, for example, the electrode mixture layer is conveyed through the interior of the furnace body. Furthermore, a plurality of blowing nozzles may be arranged, and each nozzle may be arranged so as to have a different supply direction.

The air speed of the hot air is not particularly limited, and may be, for example, 5 m/s or more, 10 m/s or more, 15 m/s or more, or 20 m/s or more. A higher air speed increases drying efficiency of the electrode mixture layer. The air speed of the hot air may be 60 m/s or less, 50 m/s or less, 40 m/s or less, or 30 m/s or less.

### <Exhaust Equipment>

The laser drying device may also comprise exhaust equipment. By providing exhaust equipment, steam generated from the electrode mixture layer can be recovered, thereby improving drying efficiency. The steam can be water vapor or other gases.

The exhaust equipment may be configured so as to, for example, suction in steam from an exhaust port by means of an exhaust fan and discharge the steam to the outside of the furnace body via an exhaust duct. The output of the exhaust fan and the dimensions of the exhaust port and exhaust duct may be appropriately determined in consideration of the amount of steam generated, the internal pressure of the furnace body, etc.

From the viewpoint of improving drying efficiency, it is preferable that the exhaust port be arranged above the electrode mixture layer and in a position which does not interfere with laser irradiation. The distance between the exhaust port and the electrode mixture layer may be such that vapor can be suctioned. The number of exhaust ports is not particularly limited.

### <Conveying Equipment>

The conveying equipment is not particularly limited, and may be, for example, a roller conveyor, a belt conveyor, etc. The electrode mixture layer may be arranged on, for example, a conveying path and introduced into the interior of the furnace body and conveyed to the outside of the furnace body.

The electrode mixture layer may be irradiated with laser light while being conveyed through the furnace body interior by the conveying equipment. In this case, the conveying speed may be appropriately determined in consideration of the output of the laser light source, the amount of energy required to dry the electrode mixture layer, etc. The conveying speed may be, for example, 0.1 m/s or more, 0.3 m/s or more, 0.5 m/s or more, or 1.0 m/s or more, or 3.0 m/s or less, 2.5 m/s or less, or 2.0 m/s or less.

The conveying equipment may be connected to other devices such as an application device for the electrode mixture layer and an electrode laminate winding device.

### <<Electrode Laminate Production Method>>

A method for the production of an electrode laminate using the laser drying device according to the present disclosure, the method comprising the step of:
irradiating the electrode mixture layer applied to a current collector layer with laser light from the laser light source through the laser-transmitting protective plate laminate.

According to the present disclosure, there can be provided a method for the production of an electrode laminate which can suppress drying unevenness in the electrode mixture layer, even when a plurality of protective plate pieces are arranged side-by-side in the plane direction to form a large-area protective plate.

The method of the present disclosure is a method for the production of an electrode laminate using the laser drying device of the present disclosure. Regarding the laser drying device, reference can be made to the foregoing description of the laser drying device.

The method of the present disclosure comprises irradiating the electrode mixture layer applied to a current collector layer with laser light from the laser light source through the laser-transmitting protective plate laminate. Regarding the laser source, the laser-transmitting protective plate laminate, the electrode mixture layer, and the laser light, reference can be made to the foregoing description of the laser drying device. By irradiating the electrode mixture layer with laser light, the dispersion medium contained in the electrode mixture layer volatilizes, whereby an electrode active material layer is formed.

The dispersion medium contained in the electrode mixture layer is not particularly limited, and may be, for example, a non-polar solvent such as heptane, xylene, or toluene, or a polar solvent such as water, a tertiary amine solvent, an ether solvent, a thiol solvent, a ketone solvent (for example, diisobutyl ketone), or an ester solvent (for example, butyl butyrate).

The content of the dispersion medium is not particularly limited, and may be, for example, a quantity such that the solid content of the electrode mixture layer is 30% or more, 35% or more, 40% or more, 45% or more, or 50% or more, and may be a quantity such that the solid content of the electrode mixture layer is 80% or less, 75% or less, 70% or less, 65% or less, or 60% or less.

The method for applying the electrode mixture layer is not particularly limited, and a doctor blade method, a die coating method, a gravure coating method, a spray coating method, an electrostatic coating method, a bar coating method, etc., may be adopted.

The irradiation time of the laser light is not particularly limited, and for example, irradiation may be performed until the decreasing rate drying period of the electrode mixture layer is reached. The irradiation time of the laser light may be, for example, 30 seconds or more, 1 minute or more, or 2 minutes or more, and may be 30 minutes or less, 20 minutes or less, or 10 minutes or less.

### <Electrode Laminate>

The electrode laminate may comprise an electrode active material layer and a current collector layer. The electrode active material layer may be a positive electrode active material layer or a negative electrode active material layer. The electrode laminate may also be a bipolar electrode laminate having a positive electrode active material layer and a negative electrode active material layer.

### (Electrode Active Material Layer)

When the electrode active material layer of the present disclosure is a positive electrode active material layer, the positive electrode active material layer contains at least a positive electrode active material. When the electrode active material layer is a negative electrode active material layer, the negative electrode active material layer contains at least a negative electrode active material. The electrode active material layer may further contain, as desired, a binder, a solid electrolyte, a conductive additive, etc. The electrode active material layer may also contain various other additives. The contents of the positive electrode active material, the negative electrode active material, the binder, the solid electrolyte, the conductive additive, etc., in the electrode active material layer may be appropriately determined in accordance with the desired battery performance.

The material of the positive electrode active material is not particularly limited as long as it is capable of absorbing and releasing lithium ions. Examples of the positive electrode active material include, but are not limited to, lithium cobalt oxide (LiCoO₂), lithium nickel oxide (LiNiO₂), lithium manganese oxide (LiMn₂O₄), lithium iron phosphate (LFP), lithium manganese iron phosphate (LMFP), nickel-cobalt-manganese lithium oxide (NCM: LiCO_{1/3}Ni_{1/3}Mn_{1/3}O₂), nickel-cobalt-aluminum lithium oxide (LiNi_{0.8}(CoAl)_{0.2}O₂), and heteroelement-substituted Li—Mn spinels having a composition represented by Li₁₊ₓMn_{2-x-y}M_{y}O₄ (where M is one or more metal elements selected from Al, Mg, Co, Fe, Ni, and Zn).

The form of the positive electrode active material is not particularly limited as long as it is a form which is generally adopted for the positive electrode active material of batteries. The positive electrode active material may be, for example, particulate. The positive electrode active material may be primary particles or secondary particles formed by aggregation of a plurality of primary particles. The average particle diameter D₅₀ of the positive electrode active material may be, for example, 1 nm or more, 5 nm or more, or 10 nm or more, and may be 500 μm or less, 100 μm or less, 50 μm or less, or 30 μm or less. The average particle diameter D₅₀ is the particle diameter (median diameter) at 50% of the integrated value in the volume-based particle size distribution determined by a laser diffraction/scattering method.

As the negative electrode active material, various materials which have a potential (charge/discharge potential) for absorbing and releasing lithium ions that is lower than that of the positive electrode active material of the present disclosure can be used. The material of the negative electrode active material is not particularly limited, and may be metallic lithium or a material which is capable of absorbing and releasing metal ions such as lithium ions. Examples of materials which are capable of absorbing and releasing metal ions such as lithium ions include, but are not limited to, alloy-based negative electrode active materials, carbon materials, and lithium titanate (Li₄Ti₅O₁₂).

The alloy-based negative electrode active material is not particularly limited, and examples thereof include Si alloy-based negative electrode active materials and Sn alloy-based negative electrode active materials. Examples of Si alloy-based negative electrode active materials include silicon, silicon oxide, silicon carbide, silicon nitride, and solid solutions thereof. The Si alloy-based negative electrode active material can contain metal elements other than silicon, such as Fe, Co, Sb, Bi, Pb, Ni, Cu, Zn, Ge, In, Sn, Ti, etc. Examples of Sn alloy-based negative electrode active materials include tin, tin oxide, tin nitride, and solid solutions thereof. The Sn alloy-based negative electrode active material can contain metal elements other than tin, such as Fe, Co, Sb, Bi, Pb, Ni, Cu, Zn, Ge, In, Ti, Si, etc.

The carbon material is not particularly limited, and examples thereof include hard carbon, soft carbon, graphite, etc.

The form of the negative electrode active material is not particularly limited as long as it is a form which is generally adopted for the negative electrode active material of batteries. The negative electrode active material may be, for example, in the form of particles or a sheet.

The material of the binder is not particularly limited. The binder may be, for example, polyvinylidene fluoride (PVdF), butadiene rubber (BR), polytetrafluoroethylene (PTFE), styrene butadiene rubber (SBR), etc., but is not limited thereto. The binder is not particularly limited, and one type may be used alone, or two or more types may be used in combination.

The material of the solid electrolyte is not particularly limited, and may be, for example, a sulfide solid electrolyte, an oxide solid electrolyte, or a polymer electrolyte.

Examples of sulfide solid electrolytes include, but are not limited to, sulfide-based amorphous solid electrolytes, sulfide-based crystalline solid electrolytes, and argyrodite-type solid electrolytes. Specific examples of sulfide solid electrolytes include Li₂S—P₂S₅-based electrolytes (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), etc.; or combinations thereof.

The sulfide solid electrolyte and the oxide solid electrolyte may be glass or crystallized glass (glass ceramics).

Examples of polymer electrolytes include, but are not limited to, polyethylene oxide (PEO), polypropylene oxide (PPO), and copolymers thereof.

The conductive additive is not particularly limited. The conductive additive may be, for example, vapor-grown carbon fiber (VGCF), acetylene black (AB), Ketjen black (KB), carbon nanotubes (CNT), carbon nanofibers (CNF), etc., but is not limited thereto. The conductive additive may be, for example, particulate or fibrous, and the size thereof is not particularly limited. The conductive additive is not particularly limited, and one type may be used alone, or two or more types may be used in combination.

### (Current Collector Layer)

The material of the current collector layer is not particularly limited, and any conductor which is commonly used in battery electrodes can be appropriately used. Examples of materials for the conductor layer include, but are not limited to, Cu, Ni, Cr, Au, Pt, Ag, Al, Fe, Ti, Zn, Co, and stainless steel. The current collector layer may also be a metal foil or a substrate on which a metal described above is plated or vapor-deposited.

The form of the current collector layer is not particularly limited, and examples thereof include foil, plate, mesh, etc. Among these, foil is preferable.

The thickness of the current collector layer is not particularly limited, and may be 0.1 μm or more, or 1 μm or more, and may be 1 mm or less, or 100 μm or less.

### EXAMPLES

The present invention will be specifically described with reference to Examples and Comparative Examples, but the present invention is not limited thereto.

### <<Evaluation of Drying Uniformity>>

### <Laser Drying Device>

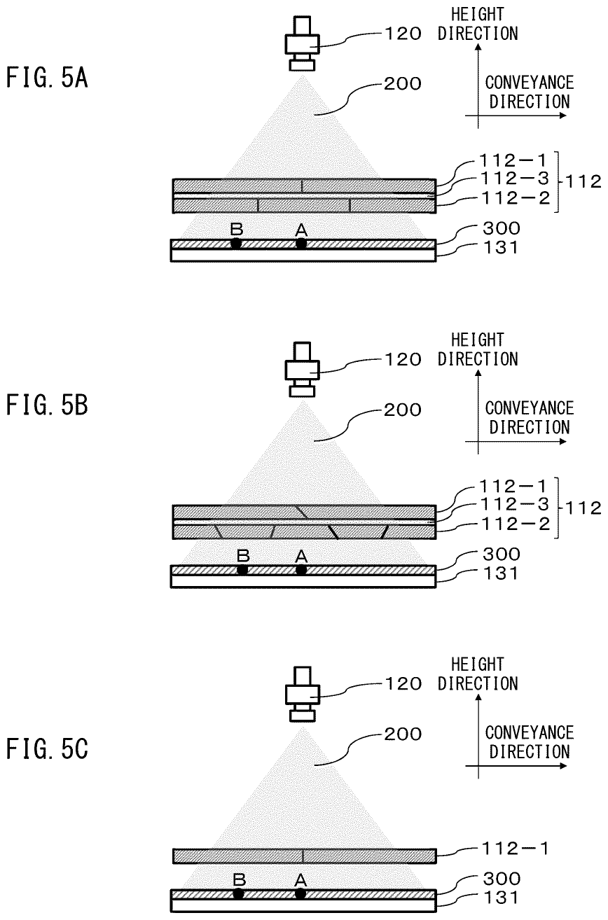

As shown in FIGS. 5(a) and 5(b), a protective plate (upper layer) 112-1 and a protective plate (lower layer) 112-2 (each 1.5 mm thick) were bonded via a 100 μm thick fluororesin film 112-3 to produce a protective plate laminate (1200 mm in width direction×1500 mm in conveying direction×3.1 mm thick).

As shown in FIG. 5A, the protective plate (upper layer) 112-1 was composed of two quartz glass protective plate pieces arranged side-by-side, and the protective plate (lower layer) 112-2 was composed of three quartz glass plates arranged side-by-side, constituting the protective plate laminate of Example 1. Note that the boundary surfaces between adjacent protective plate pieces were perpendicular to the conveyance direction.

As shown in FIG. 5B, the protective plate (upper layer) 112-1 was composed of two quartz glass protective plate pieces arranged side-by-side, and the protective plate (lower layer) 112-2 was composed of five quartz glass plates arranged side-by-side, constituting the protective plate laminate of Example 2. Note that the boundary surfaces between adjacent protective plate pieces were oblique, rather than perpendicular, to the conveyance direction.

As shown in FIG. 5C, a protective plate composed of two protective plate pieces arranged side-by-side was used as the protective plate of Comparative Example 1 in place of a protective plate laminate.

The laser drying devices of Examples 1 and 2 and Comparative Example 1 were configured as shown in FIG. 1, including the protective plate laminates of Examples 1 and 2 and the protective plate of Comparative Example 1. The laser light source had an output of 20 kW and was arranged so that the protective plate laminate or protective plate of Examples 1 and 2 and Comparative Example 1 could be irradiated with laser light in an irradiation area of 1,300 mm in the conveying direction and 1,000 mm in the width direction. The hot air supply equipment was capable of supplying hot air at 120° C. into the furnace body. The protective plate laminate or protective plate was arranged so that the distance from the electrode mixture layer was 200 mm.

### <<Drying Time Measurement>>

Electrode mixture layers (solid content 55%, basis weight: 35 mg/cm²) were dried using the laser drying devices of Examples 1 and 2 and Comparative Example 1, and the drying times of the electrode mixture layers were measured at positions A and B in FIG. 5. The results are shown in Table 1. The temperatures at positions A and B were continuously measured with a radiation thermometer, and the timing at which the decreasing rate drying period began was taken as the drying time.

TABLE 1

| | Drying time (s) | | Difference in drying time |
|---|---|---|---|
| | Position A | Position B | (\|position A − position B\|) |
| Ex 1 | 92 | 87 | 5 |
| Ex 2 | 90 | 87 | 3 |
| Comp Ex 1 | 100 | 85 | 15 |

From Table 1, there was a significant difference in drying time between position A and position B in Comparative Example 1, whereas this difference could be eliminated in Examples 1 and 2 wherein a laser-transmitting protective plate laminate having a multilayer structure in which a plurality of protective plates are stacked is used and wherein the boundaries between the plurality of protective plate pieces forming one protective plate did not coincide with the boundaries between the plurality of protective plate pieces forming the adjacent other protective plate when the protective plate laminate is viewed in the stacking direction. Thus, the laser drying device of the present disclosure could uniformly dry the electrode mixture layer.

### <<Evaluation of Drying Efficiency>>

### <Laser Drying Device>

Laser drying devices having the same configuration as shown in FIG. 1 except that the laser-transmitting protective plate laminate was a single protective plate were prepared as Reference Examples 1 to 5 and Reference Comparative Example 1. The distance y between the laser-transmitting protective plate and the electrode mixture layer was adjusted as shown in Table 2. The distance x between the laser light source and the electrode mixture layer was 1,500 mm. The protective plate was made of quartz glass, and the transmittance of the laser light emitted from the 20 kW laser light source was 99.8% at a wavelength of 970 nm. The transmittance of the laser light was measured spectrophotometrically using a UV-Vis-Near-Infrared Spectrophotometer (SolidSpec-3700DUV manufactured by Shimadzu Corporation). The temperature of the hot air supplied from the hot air supply equipment was 120° C.

### <Drying Time Measurement>

Electrode mixture layers (solid content 55%, basis weight: 35 mg/cm²) were dried using the laser drying devices of Reference Examples 1 to 5 and Reference Comparative Example 1 and the drying times were measured. The results are shown in Table 2. The temperature at the center of the electrode mixture layer was continuously measured with a radiation thermometer, and the timing at which the decreasing rate drying period began for the center of the electrode mixture layer was taken as the drying time.

TABLE 2

| | Position of laser | Position of laser- | | Drying |
|---|---|---|---|---|
| | light source | transmitting protective plate | | time |
| | x | y | x/y | (s) |
| Ref Comp Ex 1 | 1500 | 300 | 0.20 | 106 |
| Ref Ex 1 | 1500 | 200 | 0.13 | 85 |
| Ref Ex 2 | 1500 | 150 | 0.10 | 80 |
| Ref Ex 3 | 1500 | 100 | 0.07 | 74 |
| Ref Ex 4 | 1500 | 50 | 0.03 | 65 |
| Ref Ex 5 | 1500 | 10 | 0.01 | 50 |

It can be understood from Reference Examples 1 to 5 and Reference Comparative Example 1 that the drying time is shortened by reducing x/y. Thus, by using a large-area laser-transmitting protective plate and reducing x/y, drying efficiency can be improved.

REFERENCE SIGNS LIST

| | |
|---|---|
| 100 | laser drying device |
| 110 | furnace body |
| 111 | exterior base material |
| 112 | laser-transmitting protective plate laminate |
| 112-1 | protective plate (upper layer) |
| 112-1A | protective plate piece (upper layer) |
| 112-2 | protective plate (lower layer) |
| 112-2A | protective plate piece (lower layer) |
| 112-3 | fluorine resin film |
| 120 | laser light source |
| 130 | conveying equipment |
| 131 | conveyor belt |
| 132 | conveyor roller |
| 140 | hot air supply equipment |
| 141 | hot air generator |
| 142 | air supply duct |
| 143 | air supply nozzle |
| 150 | exhaust equipment |
| 200 | laser light |
| 300 | electrode mixture layer |

1. A laser drying device for drying an electrode mixture layer, wherein
the laser drying device comprises a laser light source and a furnace body,
the laser light source irradiates the electrode mixture layer with laser light through a laser-transmitting protective plate laminate of the furnace body to heat and dry the electrode mixture layer,
the protective plate laminate has a multilayer structure in which a plurality of protective plates are stacked,
the protective plates are formed by juxtaposing a plurality of protective plate pieces in a plane direction, and
when the protective plate laminate is viewed in a stacking direction, boundaries between the protective plate pieces forming one protective plate do not coincide with boundaries between the protective plate pieces forming another adjacent protective plate.

2. The device according to claim 1, wherein two of the protective plates which are adjacent to each other are bonded to each other via a fluorine resin film.

3. The device according to claim 1, wherein when a distance between the laser light source and the electrode mixture layer is defined as x and a distance between the protective plate laminate and the electrode mixture layer is defined as y, the following relationship is satisfied:
$$y / x \leq 0.15 .$$

4. The device according to claim 1, wherein the furnace body further comprises hot air supply equipment.

5. A method for the production of an electrode laminate using the device according to claim 1, the method comprising the step of:
irradiating the electrode mixture layer applied to a current collector layer with laser light from the laser light source through the laser-transmitting protective plate laminate.
